(19) United States
(12) Patent Application Publication
(10) Pub. No.: US 2024/0142313 A1
(43) Pub. Date: May 2, 2024

(54) ARRAY OF POSITION AND TEMPERATURE SENSORS

(71) Applicant: SC2N, Creteil (FR)

(72) Inventors: Gabriel Kopp, Creteil (FR); Albin Le Sergent, Cergy (FR); Franck Menard, Cergy (FR); Philippe Couasse, Cergy (FR); David Pradier, Cergy (FR); Aurélien Servettaz, Creteil (FR)

(73) Assignee: SC2N, Creteil (FR)

(21) Appl. No.: 18/280,345

(22) PCT Filed: Feb. 17, 2022
(86) PCT No.: PCT/EP2022/053980

§ 371 Date: Sep. 5, 2023

(30) Foreign Application Priority Data
Mar. 2, 2021 (FR) FR2102005

(51) Int. Cl. G01K 1/08; G01D 5/20; G01K 7/02; G01K 7/22

(52) U.S. Cl. CPC G01K 1/08; G01D 5/20; G01K 7/02; G01K 7/22

(57) ABSTRACT

The present invention relates to a sensor array comprising an inductive sensor (30, 31) and at least one temperature sensor (40, 41) for an electric machine, wherein the sensor array is arranged in a housing (10, 51, 52, 53, 54) and a single group of connectors (21) opens out of the housing (10, 20) in order to connect to an inverter of the electric machine.

The present invention relates to a sensor assembly comprising an inductive technology position sensor and a temperature sensor. This assembly is intended to measure the position and temperature for an inverter of an electric machine used in a mobility machine such as an electric vehicle or an electrically assisted bicycle.

Usually this type of assembly is composed on the one hand of an inductive sensor arranged in a housing and on the other hand of a temperature sensor arranged outside the housing.

Such an assembly requires the use either of two independent electrical harnesses or of a complex electrical harness, with at least one connector connecting the temperature sensor, at least one connector connecting the position sensor, and at least one connector connecting the inverter. Using this harness assembly increases the cost of the sensor assembly.

In addition, in vehicle engines, these sensor assemblies are required to be positioned close to a component or electrical element of the engine generating a large magnetic field such as an alternator, a motor, a reduction gear, or high-intensity electrical cables used for example for hybrid vehicles, and the presence of two harnesses increases the bulk of the assembly, which makes it difficult to integrate.

The object of the present invention is therefore to overcome one or more of the drawbacks of the assemblies of the prior art by proposing an improved position and temperature sensor assembly.

For this, the present invention proposes a sensor assembly comprising a so-called inductive technology position sensor and at least one temperature sensor for an electric machine, the sensor assembly is arranged in a housing and a single group of connections emerges from the housing to make the connection with an inverter of the electric machine.

The group of connections reduces costs and also optimizes the compactness of the assembly, which is thus less bulky.

According to one embodiment of the invention, the so-called inductive technology position sensor is arranged in the housing and connected to a first set of conductive outputs and at least one temperature sensor is arranged in the housing and connected to a second set of conductive outputs, these two sets are interconnected inside the housing, to form a single group of connections which emerges from the housing and allows connection to the inverter.

According to one embodiment of the invention, the group of connections comprises conductive wires.

According to one embodiment of the invention, the housing is made of plastic.

According to one embodiment of the invention, at least one temperature sensor is an NTC.

According to one embodiment of the invention, at least one temperature sensor is a thermocouple.

The invention also relates to an electric machine comprising a sensor assembly according to the invention.

The invention also relates to the use of the sensor assembly according to the invention in a water-cooled electric machine.

The invention also relates to the use of the sensor assembly according to the invention in an air-cooled electric machine.

The invention also relates to the use of the sensor assembly according to the invention in an oil-cooled electric machine.

The invention also relates to the use of the sensor assembly according to the invention in a gearbox.

Further aims, features and advantages of the invention will be understood better and will become more clearly apparent from reading the description given below with reference to the appended figures, which are given by way of example and in which:

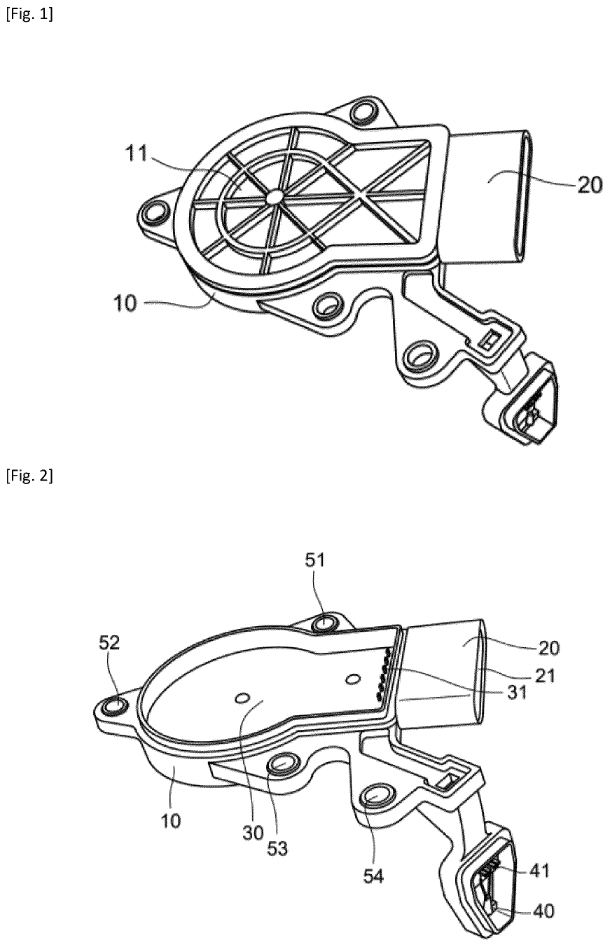

FIG. 1 is an exterior view of a sensor assembly according to the invention,

FIG. 2 is a view of the inside of the housing comprising an assembly according to one embodiment of the invention.

The invention relates to a sensor assembly intended to be used with an electric machine or an element of the transmission of a mobility machine. More specifically, the sensor assembly comprises an inductive technology sensor 30, to measure the position of a rotating element, for example of a rotor with respect to a stator, and a temperature sensor 40 to measure, for example, the temperature of the air and/or of the winding of an electric machine.

As illustrated in [FIG. 1], the sensor assembly is arranged in a housing 10.

According to one embodiment of the invention, the housing 10 illustrated in [FIG. 2] is a housing 10 made of plastic. According to another embodiment of the invention, the housing 10 is made of any material allowing its integration in an engine or gearbox environment, that is to say in an environment with high temperatures and difficult conditions.

According to one embodiment of the invention, the housing 10 includes a cover 11.

The housing 10 thus comprises an inductive position sensor 30 and a temperature sensor 40.

Arranging the two sensors in the same housing makes it possible to optimize the compactness of the assembly.

In the context of the invention, the inductive technology sensor 30 is arranged in the housing 10 and connected to a first conductive output 31 u. The temperature sensor 40 is arranged in the housing and connected to a second conductive output 41.

According to a variant of the invention, the inductive technology sensor 30 is arranged in the housing 10 and connected to a first set 31 of conductive outputs and the temperature sensor 40 is arranged in the housing and connected to a second set 41 of conductive outputs.

These two outputs or sets of outputs 31, 41 are connected inside the housing 10, to form a single group of connections 21, comprising conductive wires, which emerges from the housing via a connector 20 or a set of conductive wires and allows connection to the inverter.

The sets 31, 41 of conductive outputs each comprise at least 2 outputs.

According to one embodiment of the invention, the group of connections 21 is formed by conductive outputs 41 of the temperature sensor 40 and conductive outputs 31 of the position sensor 31.

According to one embodiment of the invention, the group of connections 21 is composed of conductive metal tabs intended to be connected to the inverter.

According to another embodiment of the invention, the group of connections 21 is composed of the combination of metal tabs and conductive wires, intended to be connected to the inverter.

The group of connections 21 reduces costs and also optimizes the compactness of the assembly, which is thus less bulky.

According to one embodiment of the invention, the housing 10 comprises elements allowing fastening thereof. Its elements are in the form of lugs having an opening 51, 52, 53, 54.

According to one embodiment of the invention, the temperature sensor 40 is an NTC.

According to one embodiment of the invention, the temperature sensor 40 is a thermocouple.

According to one embodiment of the invention, the temperature sensor 40 measures the temperature of the surrounding air. This type of configuration is for example used for an electric machine whose cooling is done with water.

According to another embodiment of the invention, the temperature sensor 40 measures the temperature of the winding. This measurement is carried out via contact with a thermally conductive blade. This type of configuration is for example used for an electric machine whose cooling is done with air or oil.

According to another embodiment of the invention, the temperature sensor 40 is used to measure the temperature of the bus bar of the electric machine.

The scope of the present invention is not limited to the details given above and allows embodiments in numerous other specific forms without moving away from the field of application of the invention. Consequently, the present embodiments should be considered to be by way of illustration, and can be modified without, however, departing from the scope defined by the claims.

1. A sensor assembly comprising:
a inductive technology position sensor; and
at least one temperature sensor for an electric machine,
wherein the sensor assembly is arranged in a housing and a single group of connections emerges from the housing to connect with an inverter of the electric machine.

2. The sensor assembly as claimed in claim 1, in which the inductive technology position sensor is arranged in the housing and connected to a first conductive output, and wherein at least one temperature sensor is arranged in the housing and connected to a second conductive output, the two conductive outputs being interconnected inside the housing, to form a single group of connections which emerges from the housing and allows connection to an inverter.

3. The sensor assembly as claimed in claim 1, in which the housing is made of plastic.

4. The sensor assembly as claimed in claim 1, in which at least one temperature sensor is an NTC.

5. The sensor assembly as claimed in claim 1, in which at least one temperature sensor is a thermocouple.

6. An electric machine comprising: a sensor assembly as claimed in claim 1.

7. The sensor assembly as claimed in claim 1, wherein the sensor assembly is used in a water-cooled electric machine.

8. The sensor assembly as claimed in claim 1, wherein the sensor assembly is used in an air-cooled electric machine.

9. The sensor assembly as claimed in claim 1, wherein the sensor assembly is used in an oil-cooled electric machine.

10. The sensor assembly as claimed in claim 1, wherein the sensor assembly is used in a gearbox.
